(19) United States
(12) Patent Application Publication
(10) Pub. No.: US 2017/0341567 A1
(43) Pub. Date: Nov. 30, 2017

(54) SYSTEM PROVIDING LIGHTING TO VEHICLE WHEELS AND RIMS

(71) Applicant: Mark C. Englert, Stockbridge, GA (US)

(72) Inventor: Mark C. Englert, Stockbridge, GA (US)

(21) Appl. No.: 15/344,141

(22) Filed: Nov. 4, 2016

Related U.S. Application Data
(60) Provisional application No. 62/342,102, filed on May 26, 2016.

(51) Int. Cl. B60Q 1/32; F21V 23/00; F21V 3/00; B62J 6/16; B62J 6/20; B62J 6/00; B60R 16/033; B60R 16/027; B60Q 1/26; F21V 23/04; B60Q 1/00; F21Y 2115/10

(52) U.S. Cl. CPC B60Q 1/326; F21V 23/0442; F21V 23/001; F21V 3/00; B62J 6/16; B60Q 1/0076; B62J 6/20; B62J 6/001; B60R 16/033; B60R 16/027; B60Q 1/2696; F21Y 2115/10; B62J 2006/008

(57) ABSTRACT

A wheel includes illumination built into the wheel, such as one or more LEDs disposed within the wheel itself. Unlike add-one lighting accessories, the LEDs may be integrated with the wheel to avoid disconnection from the wheel. The wheels can include a centrally located power supply and a switch. An optional cover may be disposed over the wheel. With the LEDs formed into the wheel, the optional covers may be flush with and shaped in a shape to match the wheel. The wheels may be wheels from cars, trucks, trailers, recreational vehicles, all-terrain vehicles, motorcycles and the like. When the wheel may be visible from both sides, as in the case with motorcycles, the LEDs may be disposed and integrated in both sides of the wheel.

### CROSS-REFERENCE TO RELATED APPLICATIONS

This application claims the benefit of priority to U.S. provisional patent application No. 62/342,102, filed May 26, 2016, the contents of which are herein incorporated by reference.

### BACKGROUND OF THE INVENTION

### 1. Field of the Invention

One or more embodiments of the invention relates generally to illuminated wheels. More particularly, the invention relates to wheels and rims having embedded light emitting diode (LED) lights disposed therein for use in cars, trucks, recreational vehicles, all-terrain vehicles (ATVs), motorcycles, and the like.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

With the increasing popularity of LEDs, various uses have been proposed to use this lighting product. On vehicles, LED systems has been used, for example, to providing lighting effects under a vehicle, where the LED system is directed to shine a light down from the underside of the vehicle, onto a road surface.

More recently, adding lighting effects to other parts of the vehicle has been performed. This lighting has been applied to vehicles as a post-production, add-on modification. In some embodiments, LED systems have been attached to wheels, around headlights, around taillights, and the like.

These add-on systems, however, suffer from several issues. For example, often, a user must make modifications to their vehicle to add on such lighting systems. These modifications may include drilling holes, using attachment devices, such as glues or screws, running electrical wires, and the like. These modifications could void warranties and could provide installation difficulties. Moreover, when lighting systems are added to moving components, such as spinning wheels, there is a safety issue should the attachment means not be strong enough or eventually fail due to heat, moisture, rotational forces, or the like.

In view of the foregoing, it is clear that these traditional techniques are not perfect and leave room for more optimal approaches to provide lighting effects on wheels, rims, spinning rims and wheel covers for vehicles.

### SUMMARY OF THE INVENTION

Embodiments of the present invention provide a wheel comprising one or more integrated LEDs disposed within the wheel; a battery pack disposed in a central region of the wheel; a switch disposed in the central region of the wheel; and wiring interconnecting the LEDs with the battery pack.

Embodiments of the present invention further provide a motorcycle wheel comprising LEDs disposed within the wheel and on both sides thereof; a battery pack disposed in a central region of the wheel; a switch disposed in the central region of the wheel; and wiring disposed within the wheel interconnecting the LEDs with the battery pack.

In some embodiments, the switch is one of a motion switch, a photo switch and a remote switch. In some embodiments, the wiring is disposed within the wheel. In some embodiments, a cover is disposed over one or more of the one or more integrated LEDs. In some embodiments, the LEDs are disposed on both sides of the wheel. In some embodiments, the LEDs are disposed in a cutout formed in the wheel.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 is a front view of a vehicle wheel having integrated LEDs disposed therein according to exemplary embodiments of the present invention;

FIG. 2 is a cross-sectional view of the vehicle wheel of FIG. 1;

FIG. 3 is a cross-sectional view of the vehicle wheel of FIG. 1 as taken along line of FIG. 1 with the cover 14 removed for clarity;

FIG. 4 is a front view of a vehicle wheel having integrated LEDs disposed therein, further including an optional opaque or transparent cover disposed over the lights;

FIG. 5 is a cross-sectional view of the vehicle wheel of FIG. 4;

FIG. 6 is an exploded view of a motorcycle wheel having integrated LEDs disposed therein, according to an exemplary embodiment of the present invention;

FIG. 7 is an exploded view of an axle attachment for the motorcycle wheel of FIG. 6;

FIG. 8 is a side view of a motorcycle having the motorcycle wheels of FIG. 6;

FIG. 9 is a front perspective view of the motorcycle wheel of FIG. 6;

FIG. 10 is a side view of a motorcycle wheel having integrated LEDs disposed therein, according to an exemplary embodiment of the present invention; and

FIG. 11 is a side view of a motorcycle wheel having integrated LEDs disposed therein, according to an exemplary embodiment of the present invention.

Unless otherwise indicated illustrations in the figures are not necessarily drawn to scale. The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

A description of an embodiment with several components in communication with each other does not imply that all such components are required. On the contrary a variety of optional components are described to illustrate the wide variety of possible embodiments of the present invention.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

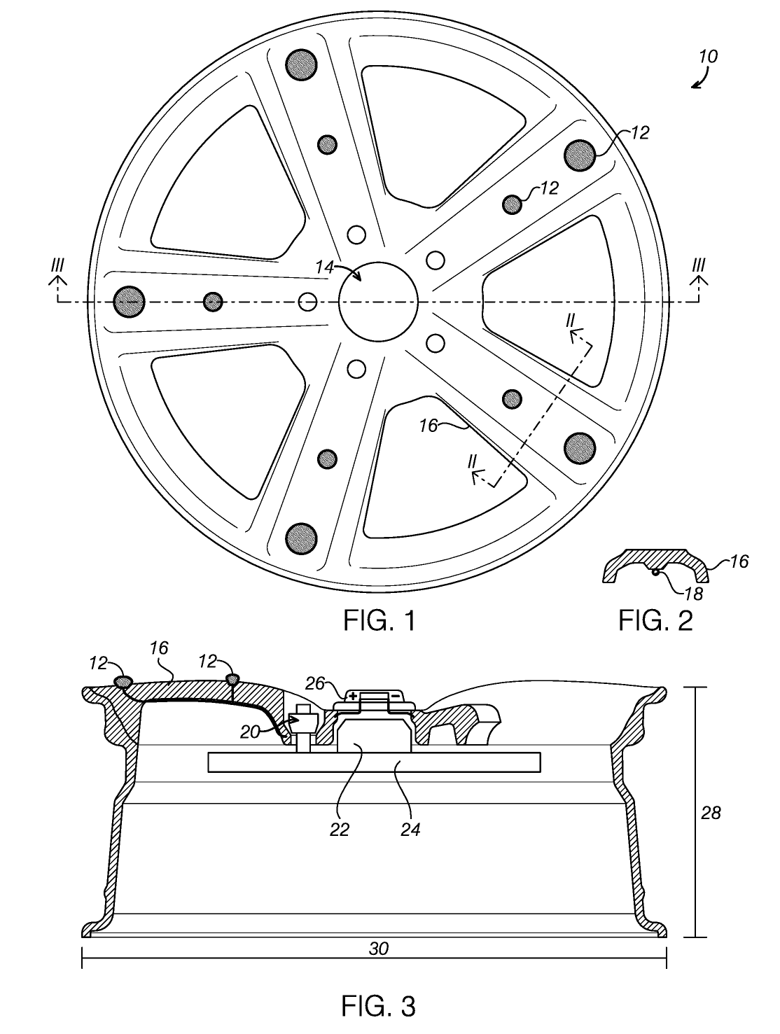

FIGS. 1 through 3 illustrate a wheel 10 for a vehicle that has lights, such as LEDs 12, disposed therein. The LEDs 12 can be integrated into the wheel 10 and permanently attached thereto. Unlike conventional lighting, with the LEDs 12 integrated into the wheel 10, there is no risk of the lighting coming off due to centrifugal force, failed adhesive, or the like. Moreover, unlike conventional, after-market add-on lighting, the integrated LED lighting of the present invention is created as an integral unit, with the wiring, switch and power supply all integrated into the wheel 10. A battery cover 14 may cover many of the components at a central portion of the wheel 10. Within the battery cover, as shown in FIG. 2, the battery pack 26 may be disposed.

As shown in FIGS. 2 and 3, wiring 18 may extend from the LEDs 12 to the battery pack 26. In some embodiments, the wiring 18 may be embedded within the wheel. In other embodiments, the wiring 18 may run along a path and/or a channel formed on an inside portion of the wheel 10.

In some embodiments, a switch (not shown, see FIG. 7 for an example of the switch which may be integrated below the battery cover 14) can be a remotely controlled switch, where the driver can choose when to power on or off the LEDs 12. In other embodiments, the switch may be a motion detection switch, where motion of the wheel turns on the LEDs and they turn off automatically when the wheel stops moving. In either embodiments, a light sensor or diode may be used to keep the LEDs 12 turned off when a certain level of brightness is ambient or to automatically turn on the LEDs 12 when a predetermined level of darkness is present.

The power supply may be a photo cell to rechargeable battery pack 26 on cover of 14. In some embodiments, a portion of the outer periphery of the wheel, such as a central hub or spokes 16 thereof, may be formed from solar panels, where the solar panels can charge the battery pack 26. Typically, the battery pack 26, LEDs 12 and solar panels are disposed uniformly about the wheel so that balance of the wheel is not changed by the LEDs 12 and its accompanying components.

The wheel 10 may include conventional components, as shown in FIG. 3, such as the spindle cap 22, lug nuts 20 and a brake rotor 24, for example. The wheel 10 may have various widths 28 and diameters 30 as may be known in the art, depending on the particular vehicle with which the wheel is used.

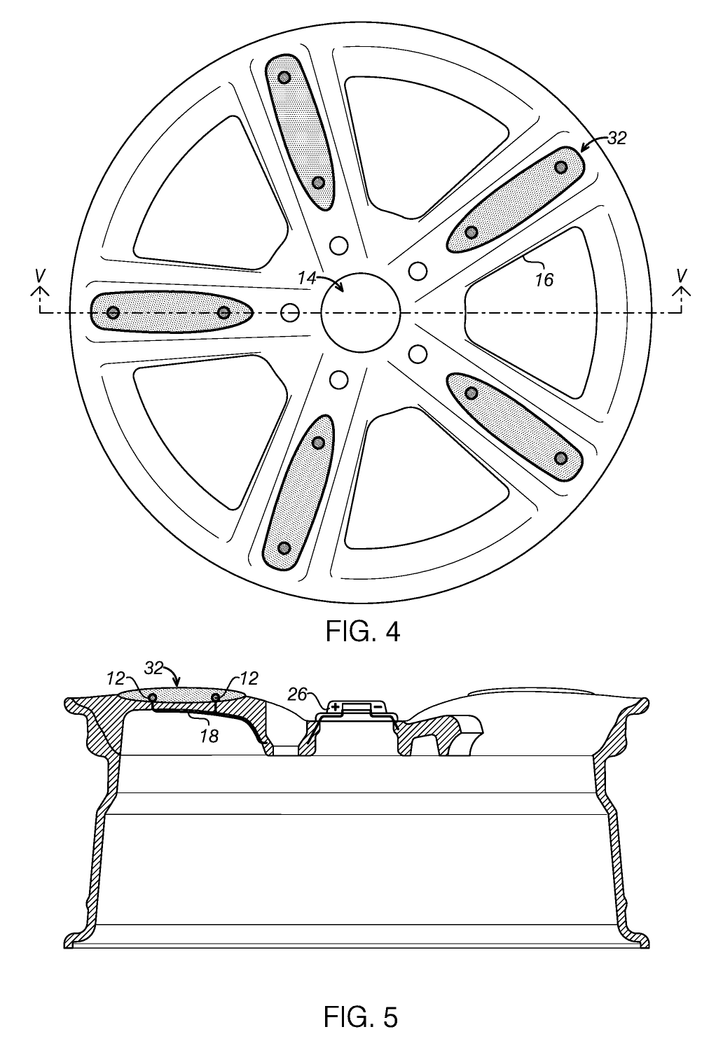

In some embodiments, as shown in FIGS. 4 and 5, a cover 32 may be disposed over the LEDs 12. The cover 32 may serve several purposes, including protecting the LEDs 12 from physical or weather related damage, diffuse the light from the LEDs 12, and provide an aesthetically pleasing appearance for the exterior of the wheel 10. The cover 32 may be opaque, transparent, patterned, colored or the like. The cover 32, of course, is an optional item that may or may not be present on the wheel 10.

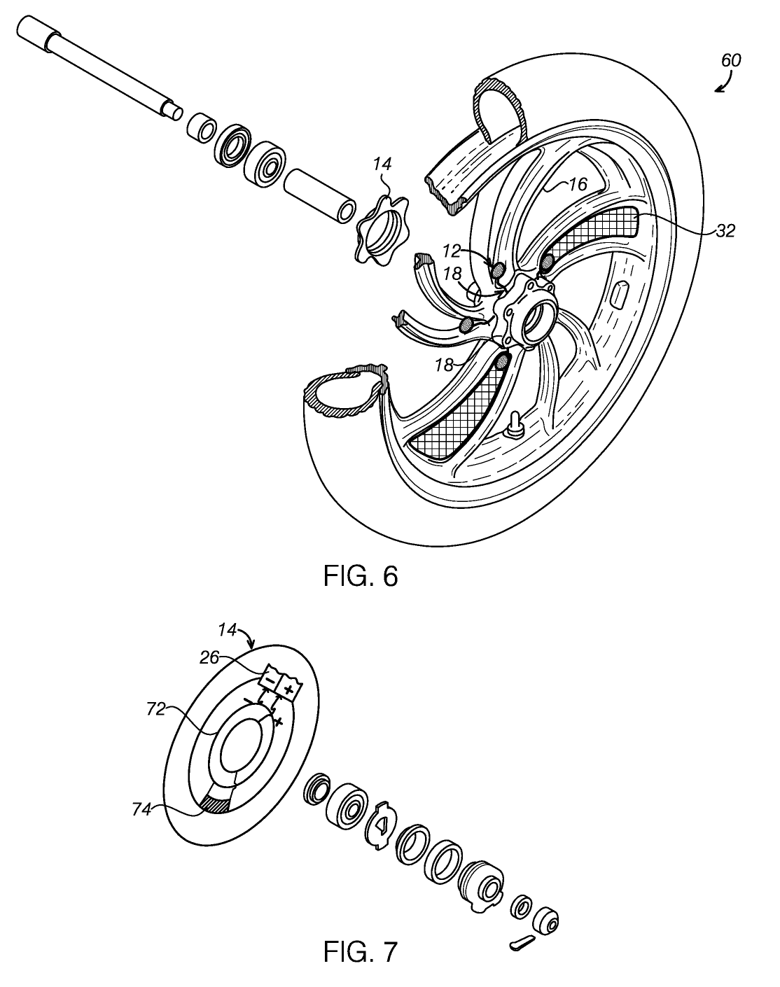

Referring now to FIGS. 6 and 7, there is shown a motorcycle wheel 60 having integrated LEDs 12 formed therein. The motorcycle wheel 60 described with respect to this embodiment of the present invention can be similar to the wheel 10 described above, however the LEDs 12 would be disposed on both sides of the motorcycle wheel 60.

Similar to the wheel 10 described above, the motorcycle wheel 60 can be formed with an integrated switch 74 and power supply, such as a battery 26. The switch 74 can be a remote switch, a movement-triggered switch, or the like. The power supply is typically a rechargeable battery. The battery 26 may be charged with a solar panel (not shown), for example, disposed on at least a portion of the exterior of the motorcycle wheel. Thus, what is obtained is a self-contained, self-powered, integrated LED motorcycle wheel 60, 76, 90, 100, 110.

The motorcycle wheel 60, 76, 90, 100, 110 can include wiring 18 connecting the battery 70 to the LEDs 12. Typically, the wiring 18 is embedded into the wheel so as to be virtually invisible to the user and to prevent disconnection or tangling. An axle cover 14 can cover the battery 26, switch 74 and related components.

In some embodiments, a connector ring 72 may be disposed within the axle cover 14. The connector ring 72 may include concentric rings or hard wiring, for positive and negative power from the battery 26. This allows each spoke containing a LED 12 to have easy access to a power terminal. Of course, other power connections may be used within the embodiments of the present invention.

Like the wheel 10 described above, the motorcycle wheel 60 can include optional covers 32 to be disposed over the LEDs 12. The covers 32 may be opaque, transparent, formed with a pattern for diffusing light, or the like.

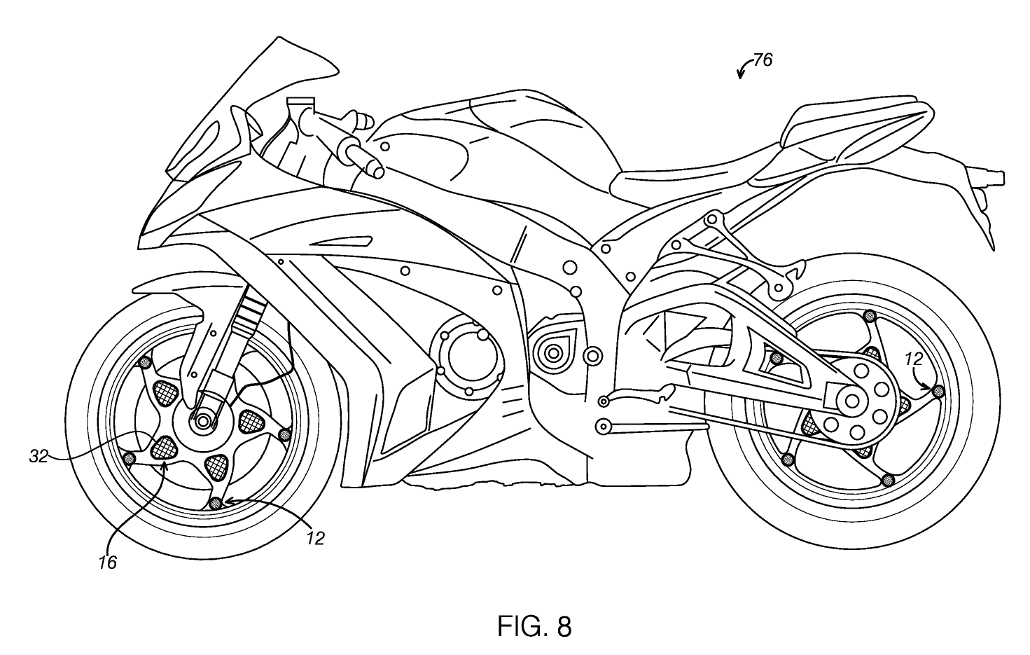

FIG. 8 shows a motorcycle 76 having the LED-integrated wheels 60 of the present invention, having LEDs 12 therein. Typically, the LEDs 12 are disposed on spokes 16 of the wheels 60, but other configurations may be formed within the scope of the present invention. FIG. 8 shows an alternative type of cover 32. In some embodiments, the LEDs 12 can be disposed at different locations on the wheel 60 and some or all may be covered with the covers 32.

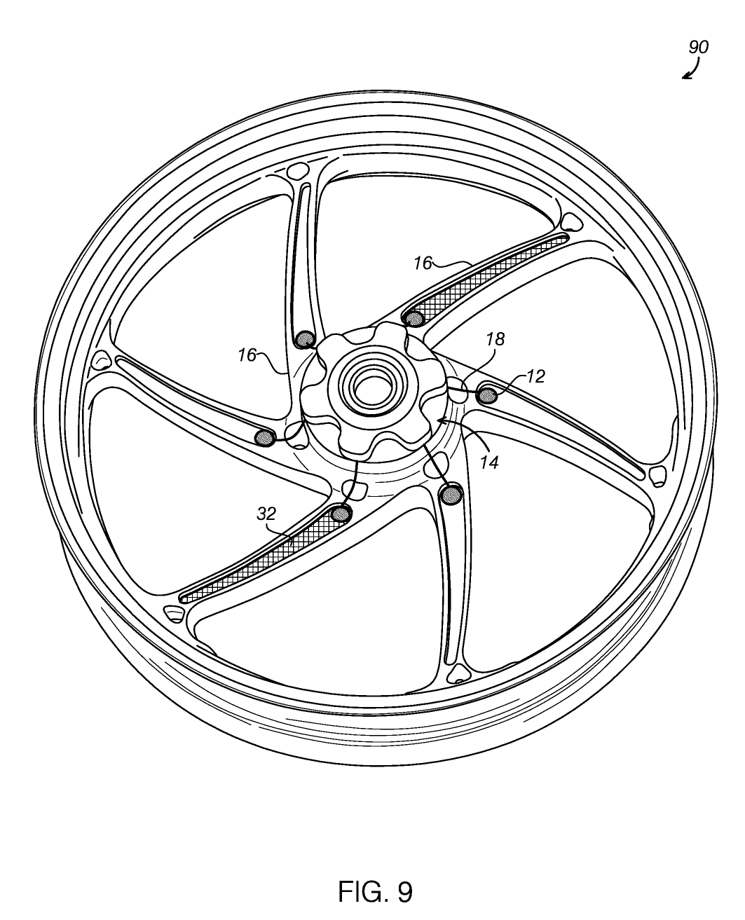

FIG. 9 shows an embodiment of a motorcycle wheel 90 having a plurality of LEDs 12 disposed along each spoke 16. Optional covers 32 may be disposed over the LEDs 12 or over an entire length of the spoke 16, as shown in FIG. 9. In this manner, the light from the LEDs 12 may diffuse over the length of the cover 32 to provide a different lighting effect.

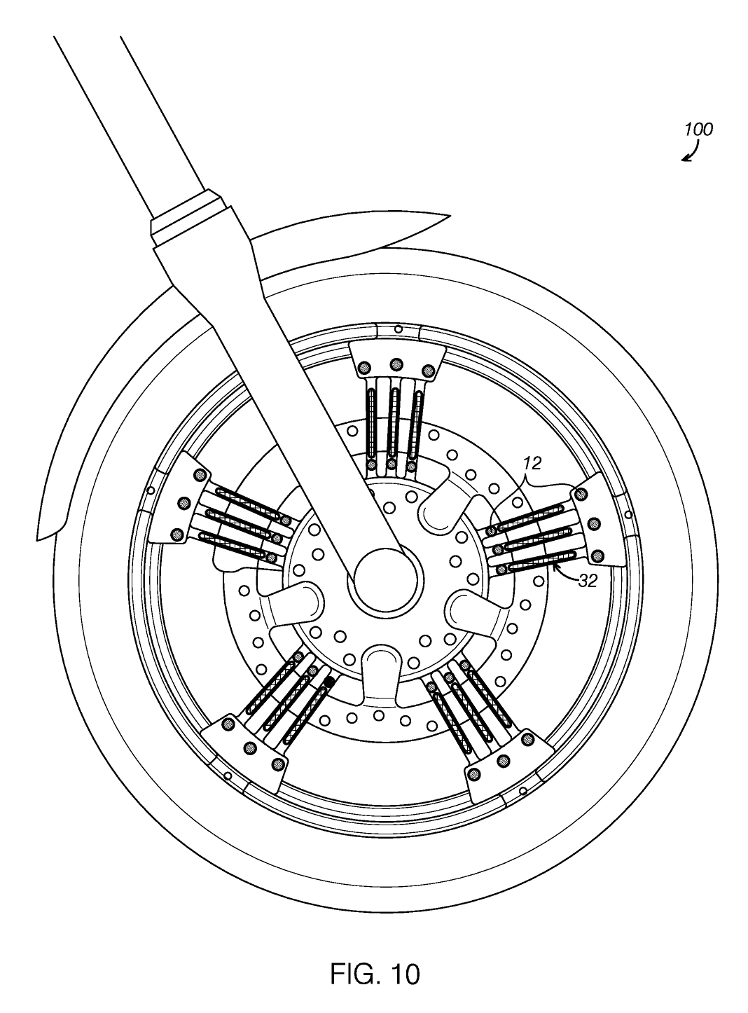

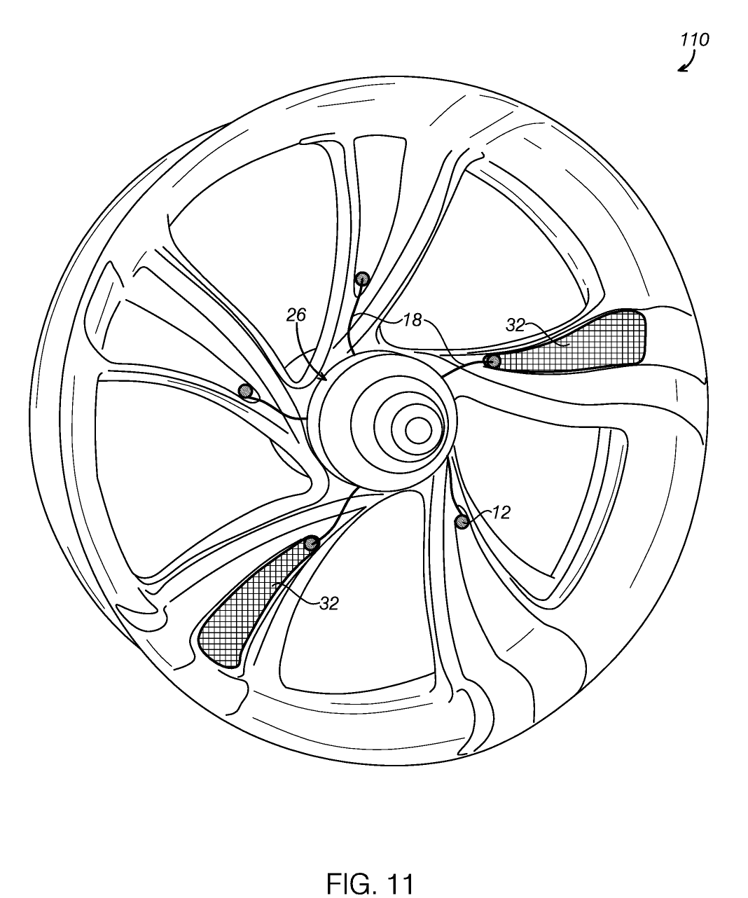

FIG. 10 shows a further embodiment of a motorcycle wheel 100 having LEDs 12 disposed therein. Optional covers 32 may be disposed over some or all of the LEDs 12. Similarly, FIG. 11 shows a further embodiment of a motorcycle wheel 110 having LEDs 12 disposed therein. Optional covers 32 may be disposed over some or all of the LEDs 12. In FIG. 11, the wiring 114 is shown above the wheel, but is typically embedded within the wheel itself. The battery (not shown), switch (not shown) and like components may be disposed in a central region 14 of the wheel 110.

While the above describes individual LEDs, multiple LEDs, such as an LED illumination bar may be used to generate light at a particular location. Furthermore, other designs may be incorporated to position light at desired locations. For example, a single LED may be used with fiber optics to create multiple illuminated locations at a location other than the LED itself. In some embodiments, fiber optics may be used to create various effects in addition to or in place of the LEDs.

The LEDs can be positioned at various locations on the base structure (the wheel, motorcycle wheel, or the like). For example, the LEDs may be positioned to direct light outward, away from the structure. In some embodiments, the LED's may be positioned to provide light toward the vehicle. In some embodiments, the LEDs may be positioned to provide light toward an interior of the wheel. In some embodiments, the LEDs may be positioned at a uniform distance from the hub of the wheel, providing a circular looking light when the wheel is moving. In other embodiments, the LEDs may be positioned at different locations, providing different effects when the wheel is in motion. The LEDs can be disposed in various colors, as desired for effect, safety of the like. In some embodiments, the LEDs can be multi-color LEDs or an LED illumination bar where the user can select the color of the LED by various manners known in the art.

While the above describes battery charging via solar panels, in some embodiments, the batteries may be charged by other means. For example, a motion-type charging system may be used, where motion of the wheel provides a charge to the battery. In some embodiments, a small current generation rotor and stator may be disposed within the wheel, where motion of the wheel generates power and power electronics may be incorporated into the battery, for example, for receiving a charging current from the generator. Of course, other charging systems, as may be known in the art, may be used within the scope of the present invention.

In some embodiments, the battery and charger may be eliminated from the LED system and a power generator may be used to generate power to light the LEDs when the vehicle is in motion. In this embodiment, power electronics may be used to prevent an over-current condition, where a maximum current is delivered to the LEDs once a given tire rotation is reached. In this embodiment, the switch may also be eliminated, as the rotation of the wheel itself would automatically turn on the LEDs, and they would automatically turn off when wheel rotation stops.

When a power supply, such as a battery, is used, various electrical connections may be used to connect the LEDs with the power supply. Typically, each LED may be wired to the battery, often with each “spoke” of LEDs wired in parallel with each other spoke, and each LED in the spoke wired in series. Of course, other wiring schemes may be used within the scope of the present invention.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A wheel, comprising:
one or more integrated LEDs disposed within the wheel;
a battery pack disposed in a central region of the wheel;
a switch disposed in the central region of the wheel; and
wiring interconnecting the LEDs with the battery pack.

2. The wheel of claim 1, wherein the switch is one of a motion switch, a photo switch and a remote switch.

3. The wheel of claim 1, wherein the wiring is disposed within the wheel.

4. The wheel of claim 1, wherein the wiring is embedded within the wheel.

5. The wheel of claim 1, further comprising a cover disposed over one or more of the one or more integrated LEDs.

6. The wheel of claim 1, wherein the LEDs are disposed on one or both sides of the wheel.

7. The wheel of claim 6, wherein the wheel is a motorcycle wheel.

8. The wheel of claim 1, wherein the LEDs are disposed in a cutout formed in the wheel, and wherein the LEDs include a single LED or multiple LEDs in an LED illumination bar.

9. A motorcycle wheel, comprising:
LEDs disposed within the wheel and on both sides thereof;
a battery pack disposed in a central region of the wheel;
a switch disposed in the central region of the wheel; and
wiring disposed within the wheel interconnecting the LEDs with the battery pack.

10. The motorcycle wheel of claim 9, wherein the switch is one of a motion switch, a remote switch and a photo cell.

11. The motorcycle wheel of claim 9, further comprising a cover disposed over one or more of the one or more integrated LEDs.

12. The motorcycle wheel of claim 9, wherein the LEDs are disposed in a cutout formed in the wheel.
